(19) United States
(12) Patent Application Publication
(10) Pub. No.: US 2009/0154720 A1
(43) Pub. Date: Jun. 18, 2009

(54) SOUND OUTPUT CONTROL DEVICE AND SOUND OUTPUT CONTROL METHOD

(76) Inventor: Yutaka OKI, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/328,061

(22) Filed: Dec. 4, 2008

(30) Foreign Application Priority Data
Dec. 18, 2007 (JP) 2007-326237

(51) Int. Cl. H04R 1/10

(52) U.S. Cl. 381/74

(57) ABSTRACT

According to one embodiment, an output control module detects whether a wearing state of the first headphone and the second headphone is a first state in which both the first headphone and the second headphone are worn on the human body, or a second state in which one of the first headphone and the second headphone is worn on the human body and the other of the first headphone and the second headphone is not worn on the human body, sends, in a case of the first state, a left-channel audio signal and a right-channel audio signal to the first headphone and the second headphone, respectively, and generates, in a case of the second state, a monaural audio signal by mixing the left-channel audio signal and the right-channel audio signal, and sends the generated monaural audio signal to the one of the first headphone and the second headphone.

### CROSS-REFERENCE TO RELATED APPLICATIONS

This application is based upon and claims the benefit of priority from Japanese Patent Application No. 2007-326237, filed Dec. 18, 2007, the entire contents of which are incorporated herein by reference.

### BACKGROUND

1. Field

One embodiment of the invention relates to a sound output control device which outputs audio signals to a first headphone and a second headphone, a sound playback apparatus and a sound output control method.

2. Description of the Related Art

In recent years, various kinds of portable playback apparatuses, such as media players and music players, have been developed. In usual cases, a pair of headphones are used to receive and listen to audio signals of, e.g. music, which are played back by the portable playback apparatus. The pair of headphones include a headphone for a left channel and a headphone for a right channel. A user wears the two headphones on the left ear and right ear, thus being able to listen to sound corresponding to a stereo audio signal.

Jpn. Pat. Appln. KOKAI Publication No. 2006-304052 discloses an audio signal control method which boosts a low-frequency component of an audio signal when it is detected that an ear pad portion of a headphone is displaced from the user's ear.

In addition, Jpn. Pat. Appln. KOKAI Publication No. 2007-81633 discloses a bone-conduction speaker apparatus. In order to prevent sound leak from a bone-conduction speaker, this bone-conduction speaker apparatus has a function of determining whether the bone-conduction speaker is in contact with the human body, and stopping power supply to the bone-conduction speaker when the bone-conduction speaker is out of contact with the human body.

In the meantime, in general, a stereo audio signal is composed on the presupposition that the stereo audio signal is listened to by both ears of the user, and the stereo audio signal includes a left-channel audio signal for the left ear and a right-channel audio signal for the right ear. In usual cases, the left-channel audio signal includes an audio signal component which is not included in the right-channel audio signal, and the right-channel audio signal includes an audio signal component which is not included in the left-channel audio signal. If only one of the left-channel audio signal and right-channel audio signal is listened to by one of the user's ears, the user would hear unnatural sound.

Therefore, it is necessary to realize a novel function which can output sound, which is free of unnaturalness to a user, no matter whether the user listens to an audio signal by both ears or by one of the ears.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the structure of a sound playback apparatus according to an embodiment of the invention;

FIG. 2 shows a state in which a headphone, which is used in the sound playback apparatus of the embodiment, is worn on the ear;

FIG. 3 is an exemplary block diagram showing a first example of the specific structure of the sound playback apparatus of the embodiment;

FIG. 4 is an exemplary block diagram showing a second example of the specific structure of the sound playback apparatus of the embodiment;

FIG. 5 shows a state in which a sound output control module, which is provided in the sound playback apparatus of the embodiment, executes wireless communication with each headphone and receives a wearing detection signal;

FIG. 6 shows an example of an output signal of a contact sensor which is provided on the headphone used in the sound playback apparatus of the embodiment;

FIG. 7 is an exemplary flow chart illustrating the procedure of a stereo/monaural switching process which is executed by the sound playback apparatus of the embodiment;

FIG. 8 is an exemplary block diagram showing a structure example of the sound output control module which is provided in the sound playback apparatus of the embodiment;

FIG. 9 is an exemplary block diagram showing a structure example of a stereo/monaural switching module provided in the sound output control module shown in FIG. 8;

FIG. 10 is an exemplary block diagram showing another structure example of the stereo/monaural switching module provided in the sound output control module shown in FIG. 8; and

FIG. 11 is an exemplary block diagram showing another structure example of the sound output control module which is provided in the sound playback apparatus of the embodiment.

### DETAILED DESCRIPTION

Various embodiments according to the invention will be described hereinafter with reference to the accompanying drawings. In general, according to one embodiment of the invention, there is provided a sound output control device comprising: an output control module configured to detect, based on a first wearing detection signal which is sent from a first headphone and a second wearing detection signal which is sent from a second headphone, whether a wearing state of the first headphone and the second headphone is a first state in which both the first headphone and the second headphone are worn on the human body, or a second state in which one of the first headphone and the second headphone is worn on the human body and the other of the first headphone and the second headphone is not worn on the human body, to send, in a case of the first state, a left-channel audio signal and a right-channel audio signal, which are included in a stereo audio signal which is output from a playback unit, to the first headphone and the second headphone, respectively, and to generate, in a case of the second state, a monaural audio signal by mixing the left-channel audio signal and the right-channel audio signal to send the generated monaural audio signal to the one of the first headphone and the second headphone.

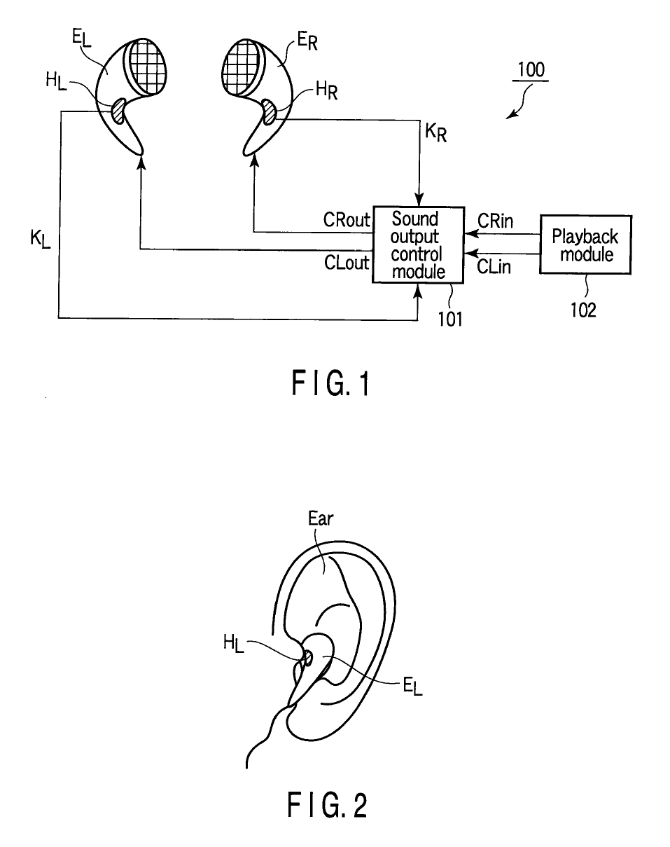

To begin with, referring to FIG. 1, a structure example of a sound playback apparatus according to an embodiment of the present invention is described. The sound playback apparatus 100 is an apparatus for outputting sound corresponding to an audio signal which is played back by a playback module 102. The sound playback apparatus 100 includes a pair of headphones E_{L} and E_{R}, and a sound output control module 101.

The playback module 102 outputs a stereo audio signal. The stereo audio signal includes a left-channel audio signal CLᵢₙ and a right-channel audio signal CRᵢₙ. The stereo audio signal is, for instance, (1) an audio signal which is output from a microphone, (2) an audio signal which is played back from a recording medium such as a magnetic tape, an optical disc or a memory, or (3) an audio signal which is output from a television or a radio. For example, the playback module 102 can be realized as a player apparatus which plays back audio data that is stored in a recording medium. Audio data which is stored in the recording medium is, for instance, a stereo audio source which is recorded in stereo. In this case, the playback module 102 plays back the audio data, thereby outputting a stereo audio signal (left-channel audio signal CLᵢₙ and right-channel audio signal CRᵢₙ) corresponding to the audio data. The stereo audio signal (left-channel audio signal CLᵢₙ and right-channel audio signal CRᵢₙ) is supplied to the sound output control module 101.

The headphone E_{L} is, for example, a first headphone (also called “earphone”) which outputs sound corresponding to the left-channel audio signal, and is worn on the left ear in use. The headphone E_{R} is, for example, a second headphone (also called “earphone”) which outputs sound corresponding to the right-channel audio signal, and is worn on the right ear in use. The headphones E_{L} and E_{R} are used in order to output sound corresponding to the stereo audio signal.

The sound output control module 101 functions as a sound output control device which outputs audio signals to the first headphone E_{L} and the second headphone E_{R}. The sound output control module 101 has two operation modes, namely, a stereo output mode and a monaural output mode.

The switching of the operation mode between the stereo output mode and a monaural output mode is executed on the basis of a first wearing detection signal K_{L} which is sent from the first headphone E_{L}, and a second wearing detection signal K_{R} which is sent from the second headphone E_{R}. The first wearing detection signal K_{L} is a signal which is indicative of whether or not the first headphone E_{L} is worn on the human body. The second wearing detection signal K_{R} is a signal which is indicative of whether or not the second headphone E_{R} is worn on the human body.

On the basis of the first wearing detection signal K_{L} and second wearing detection signal K_{R}, the sound output control module 101 determines whether the wearing state of the headphones E_{L} and E_{R} is a first state (both-ear wearing state) in which both the headphones E_{L} and E_{R} are worn on the human body, or a second state (one-ear wearing state) in which one of the headphones E_{L} and E_{R} is worn on the human body and the other of the headphones E_{L} and E_{R} is not worn on the human body.

If the both-ear wearing state is determined, the sound output control module 101 selects the stereo output mode and operates in the stereo output mode. On the other hand, if the one-ear wearing state is determined, the sound output control module 101 selects the monaural output mode and operates in the monaural output mode.

The stereo output mode is a mode for outputting sound corresponding to the stereo audio signal. In the stereo output mode, the sound output control module 101 sends the left-channel audio signal and right-channel audio signal, which are included in the stereo audio signal that is output from the playback module 102, to the headphones E_{L} and E_{R}. Specifically, the sound output control module 101 sends the left-channel audio signal CLᵢₙ, which is input from the playback module 102, to the first headphone E_{L} as a left-channel audio output signal C_{Lout}. For example, the left-channel audio output signal CLₒᵤₜ is a signal which is equal to the left-channel audio signal CLᵢₙ, which is input from the playback module 102. Further, the sound output control module 101 sends the right-channel audio signal CRᵢₙ, which is input from the playback module 102, to the second headphone E_{R} as a right-channel audio output signal CRₒᵤₜ. For example, the right-channel audio output signal CRₒᵤₜ is a signal which is equal to the right-channel audio signal CRᵢₙ, which is input from the playback module 102.

The monaural output mode is a mode for outputting sound corresponding to the monaural audio signal. In the monaural output mode, the sound output control module 101 generates a monaural audio signal by mixing the left-channel audio signal CLᵢₙ, which is input from the playback module 102, and the right-channel audio signal CRᵢₙ, which is input from the playback module 102. The sound output control module 101 sends the generated monaural audio signal to at least one of the first headphone E_{L} and second headphone E_{R}. Although the monaural audio signal may be sent to both the first headphone E_{L} and second headphone E_{R}, the monaural audio signal may be sent to only one headphone, which is selected from the first headphone E_{L} and second headphone E_{R}. For example, one of the first headphone E_{L} and second headphone E_{R}, which is worn on the human body, is selected, and the monaural audio signal may be sent to only the selected headphone.

In general, in many cases, a left-channel audio signal (SL) and a right-channel audio signal (SR), which are included in a sound source recorded in stereo, are not correlated (SL ≠ SR). If only one of the two signals which are not correlated is listened to by only one of the ears, the user tends to more easily feel unnaturalness, than in the case where the left-channel audio signal (SL) and right-channel audio signal (SR) are listened to by the left and right ears. In the present embodiment, when a transition from the both-ear wearing state to the one-ear wearing state is detected, the operation mode of the sound output control module 101 is automatically changed from the stereo output mode to the monaural output mode. Accordingly, if one of the first headphone E_{L} and second headphone E_{R} goes out of contact with the user's ear, the audio signal that is output from the sound output control module 101 is automatically changed from the stereo audio signal to the monaural audio signal. Therefore, no matter whether the user listens to the audio signal by both ears or one ear, it becomes possible to output sound that is free of unnaturalness to the user.

In addition, there are cases in which the volume of sound, which is listenable for the user, varies between the case in which sound is listened to by both ears and the case in which sound is listened to by one ear alone. Thus, in the monaural output mode, the sound output control module 101 not only generates and sends the monaural audio signal, but also has a volume auto-adjusting function for automatically varying the volume of the generated monaural audio signal by a predetermined amount. Thereby, the sound, which is listenable for the user, can be output.

The first headphone E_{L} is provided with a first contact sensor H_{L} for detecting that the first headphone E_{L} is in contact with the human body. The first contact sensor H_{L} detects whether the first headphone E_{L} is in contact with the human body, and outputs the above-described first wearing detection signal K_{L} on the basis of the detection result. The first contact sensor H_{L} is provided at a predetermined position on the body of the first headphone E_{L}. Specifically, as shown in FIG. 2, the first contact sensor H_{L} is provided at a predetermined position on the body of the first headphone E_{L}, which comes in contact with the ear when the first headphone E_{L} is worn on the ear.

The first contact sensor H_{L} may be composed of a device which can detect contact with an object such as the human body, for instance, an electrostatic sensor or a pressure-sensitive sensor. In the case where the first contact sensor H_{L} is composed of, e.g. an electrostatic sensor, if the first contact sensor H_{L} comes in contact with the ear, the electrostatic capacitance of the first contact sensor H_{L} varies, and accordingly the voltage value of the first wearing detection signal K_{L} varies. Thus, the sound output control module 101 can determine whether the first headphone E_{L} is worn on the ear, by monitoring the voltage value of the first wearing detection signal K_{L}.

The second headphone E_{R} is provided with a second contact sensor H_{R} for detecting that the second headphone E_{R} is in contact with the human body. The second contact sensor H_{R} detects whether the second headphone E_{R} is in contact with the human body, and outputs the above-described second wearing detection signal K_{R} on the basis of the detection result. The second contact sensor H_{R} is provided at a predetermined position on the body of the second headphone E_{R}. Specifically, the second contact sensor H_{R} is provided at a predetermined position on the body of the second headphone E_{R}, which comes in contact with the ear when the second headphone E_{R} is worn on the ear.

The second contact sensor H_{R}, like the first contact sensor H_{L}, may be composed of a device which can detect contact with an object such as the human body, for instance, an electrostatic sensor or a pressure-sensitive sensor. In the case where the second contact sensor H_{R} is composed of, e.g. an electrostatic sensor, if the second contact sensor H_{R} comes in contact with the ear, the electrostatic capacitance of the second contact sensor H_{R} varies, and accordingly the voltage value of the second wearing detection signal K_{R} varies. Thus, the sound output control module 101 can determine whether the second headphone E_{R} is worn on the ear, by monitoring the voltage value of the second wearing detection signal K_{R}.

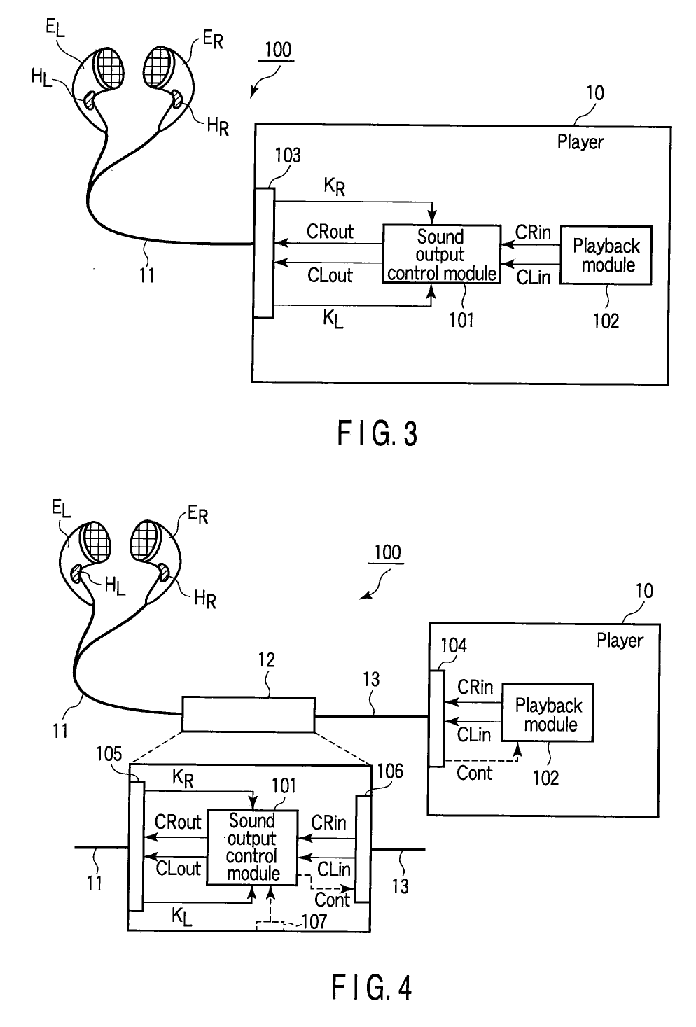

FIG. 3 shows a first example of the specific structure of the sound playback apparatus 100.

In FIG. 3, the sound output control module 101 is provided in a player apparatus 10 which includes the playback module 102. The player apparatus 10 is a device for playing back audio data which is stored in a recording medium. The player apparatus 10 is composed of, for instance, a media player, an MP3 player, or an IC recorder. The sound output control module 101 is provided between a headphone connector 103 and the playback module 102. The headphone connector 103 is a connector (e.g. headphone jack) for connecting the pair of headphones E_{L} and E_{R} to the player apparatus 10. The pair of headphones E_{L} and E_{R} are connected to the headphone connector 103, for example, via a cable 11 and a headphone plug. The headphone connector 103 includes two signal output pins to which the left-channel audio output signal CLₒᵤₜ and right-channel audio output signal CRₒᵤₜ are allocated, and two signal input pins to which the first wearing detection signal K_{L} and second wearing detection signal K_{R} are allocated. The first wearing detection signal K_{L} and second wearing detection signal K_{R} are delivered from the headphones E_{L} and E_{R} to the sound output control module 101 in the player apparatus 10 via the cable 11. It is possible to send, by wireless signals, the first wearing detection signal K_{L} and second wearing detection signal K_{R} from the headphones E_{L} and E_{R} to the sound output control module 101.

FIG. 4 shows a second example of the specific structure of the sound playback apparatus 100.

In FIG. 4, the sound output control module 101 is provided in an additional device 12 which is detachably connected to a player apparatus 10 which includes the playback module 102. The additional device 12 is an external device which receives a stereo audio signal that is output from the playback module 102, and transmits the received stereo audio signal to the headphones E_{L} and E_{R}. The additional device 12 may be realized as a remote-control unit having a volume adjusting function and a function of controlling an audio playback operation (play, stop, song selection, etc.) by the playback module 102 in the player apparatus 10.

Two connectors 105 and 106, in addition to the above-described sound output control module 101, are provided in the additional device 12. The left-channel audio output signal CLₒᵤₜ, right-channel audio output signal CRₒᵤₜ, first wearing detection signal K_{L} and second wearing detection signal K_{R} are allocated to the connector 105 on the paired headphones E_{L} and E_{R} side. The paired headphones E_{L} and E_{R} are connected to the connector 105 of the additional device 12 via a cable 11 and a headphone plug.

The left-channel audio signal CLᵢₙ and right-channel audio signal CRᵢₙ are allocated to the connector 106 on the player apparatus 10 side. The connector 106 is connected to a connector 104, which is provided in the player apparatus 10, via a cable 13 and a headphone plug.

In the case where the additional device 12 is realized as the above-described remote-control unit, the additional device 12 further includes an operation unit 107. In accordance with a user's operation of the operation section 107, the sound output control module 101 outputs a control signal Cont for remote-controlling the playback operation of the player apparatus 10 and the volume of the stereo audio signal which is played back. The control signal Cont from the sound output control module 101 is sent to the playback module 102 via the connector 106 and connector 104.

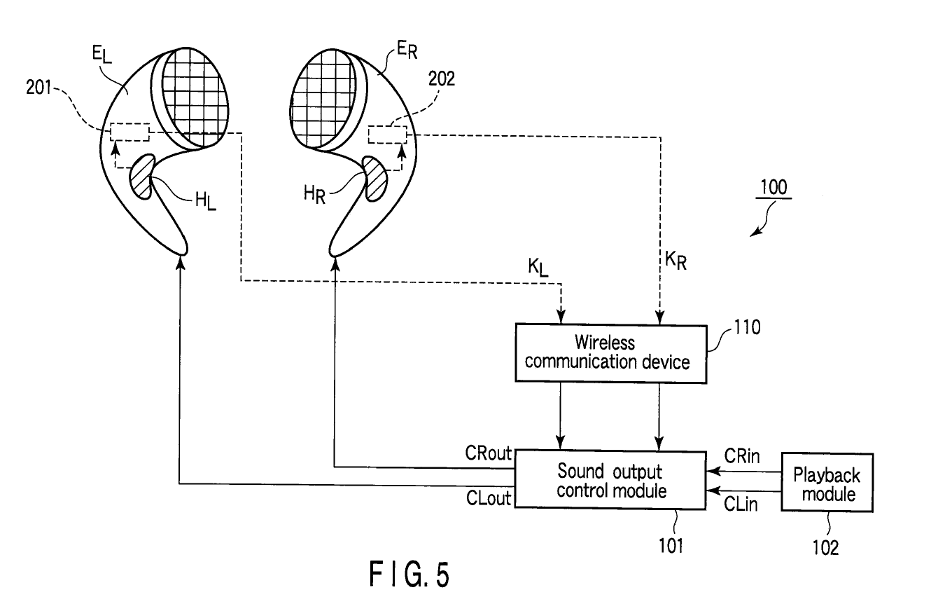

FIG. 5 shows a structure example for transmitting, by wireless signals, the first wearing detection signal K_{L} and second wearing detection signal K_{R} from the headphones E_{L} and E_{R} to the sound output control module 101.

A wireless communication device 201 for executing wireless communication is built in the first headphone E_{L}. The wireless communication device 201 transmits the first wearing detection signal K_{L}, which is output from the first contact sensor H_{L}, by a wireless signal (R_{F} signal). In addition, a wireless communication device 202 for executing wireless communication is built in the second headphone E_{R}. The wireless communication device 202 transmits the second wearing detection signal K_{R}, which is output from the second contact sensor H_{R}, by a wireless signal (RF signal).

A wireless communication device 110 is provided on the sound output control module 101 side. The wireless communication device 110 executes wireless communication with each of the wireless communication devices 201 and 202, and receives the first wearing detection signal K_{L} and second wearing detection signal K_{R} from the headphones E_{L} and E_{R}. The first wearing detection signal K_{L} and second wearing detection signal K_{R}, which are received by the wireless communication device 110, are sent to the sound output control module 101.

In the structure in which the sound output control module 101 is provided in the player apparatus 10, as described with reference to FIG. 3, the wireless communication device 110 can also be provided in the player apparatus 10.

In the structure in which the sound output control module 101 is provided in the additional device 12 on the outside of the player apparatus 10, as described with reference to FIG. 4, the wireless communication device 110 can be provided in the additional device 12.

Each of the wireless communication devices 201, 202 and 110 can be realized, for example, by a Bluetooth® module.

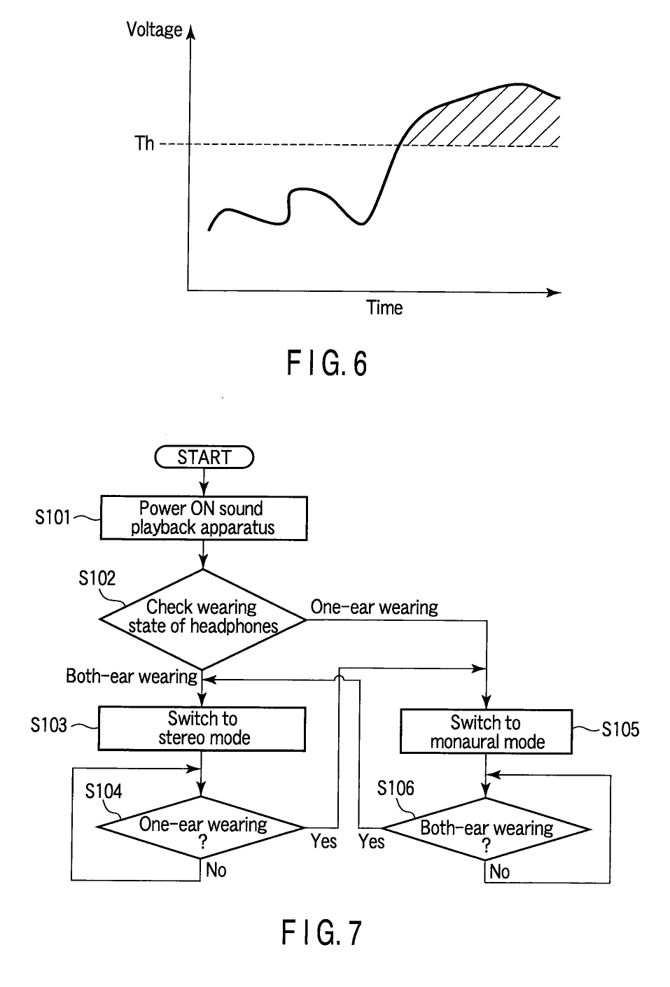

FIG. 6 shows an example of the voltage variation of each of the first wearing detection signal K_{L} and second wearing detection signal K_{R}.

If the first contact sensor H_{L} comes in contact with the human body, the voltage value of the first wearing detection signal K_{L} becomes higher than a threshold value Th. If the first contact sensor H_{L} goes out of contact with the human body, the voltage value of the first wearing detection signal K_{L} lowers to the threshold value Th or below. Similarly, if the second contact sensor H_{R} comes in contact with the human body, the voltage value of the second wearing detection signal K_{R} becomes higher than the threshold value Th. If the second contact sensor H_{R} goes out of contact with the human body, the voltage value of the second wearing detection signal K_{R} lowers to the threshold value Th or below.

Next, referring to a flow chart of FIG. 7, a description is given of a sound output control method for switching the operation mode of the sound output control module 101 between the stereo output mode and the monaural output mode.

If the sound playback apparatus 100 is powered on (step S101), the sound output control module 101 determines, on the basis of the first wearing detection signal K_{L} that is sent from the first headphone E_{L} and the second wearing detection signal K_{R} that is sent from the second headphone E_{R}, whether the wearing state of the first headphone E_{L} and second headphone E_{R} is the first state (both-ear wearing state) in which both the first headphone E_{L} and second headphone E_{R} are worn on the human body, or the second state (one-ear wearing state) in which one of the first headphone E_{L} and second headphone E_{R} is worn on the human body and the other of the first and second headphones E_{L} and E_{R} is not worn on the human body (step S102).

If the wearing state is the both-ear wearing state, the sound output control module 101 selects the stereo output mode (also referred to simply as “stereo mode”) (step S103). In this case, the sound output control module 101 sends the stereo audio signal (left-channel audio signal and right-channel audio signal) from the playback module 102 to the first headphone E_{L} and second headphone E_{R}.

If the wearing state is the one-ear wearing state, the sound output control module 101 selects the monaural output mode (also referred to simply as “monaural mode”) (step S105). In this case, the sound output control module 101 generates a monaural audio signal by mixing the left-channel audio signal and the right-channel audio signal, which are included in the stereo audio signal from the playback module 102, and sends the monaural audio signal to at least one of the first headphone E_{L} and second headphone E_{R}. Although the monaural audio signal may be sent to both the first headphone E_{L} and second headphone E_{R}, the monaural audio signal may be sent to only one headphone, which is selected from the first headphone E_{L} and second headphone E_{R}. For example, one of the first headphone E_{L} and second headphone E_{R}, which is worn on the human body, is selected, and the monaural audio signal may be sent to only the selected headphone. Thereby, sound leak from the headphone, which is not worn on the human body, can be prevented.

In each operation mode of the stereo output mode and monaural output mode, the sound output control module 101 continues to monitor the first wearing detection signal K_{L} and the second wearing detection signal K_{R}.

While the sound output control module 101 is operating in the stereo output mode, the sound output control module 101 determines, on the basis of the first wearing detection signal K_{L} and second wearing detection signal K_{R}, whether a transition occurs from the both-ear wearing state to the one-ear wearing state (step S104).

If the transition from the both-ear wearing state to the one-ear wearing state is detected (YES in step S104), the sound output control module 101 selects the monaural output mode and switches the operation mode from the stereo output mode to the monaural output mode (step S105).

While the sound output control module 101 is operating in the monaural output mode, the sound output control module 101 determines, on the basis of the first wearing detection signal K_{L} and second wearing detection signal K_{R}, whether a transition occurs from the one-ear wearing state to the both-ear wearing state (step S106).

If the transition from the one-ear wearing state to the both-ear wearing state is detected (YES in step S106), the sound output control module 101 selects the stereo output mode and switches the operation mode from the monaural output mode to the stereo output mode (step S103).

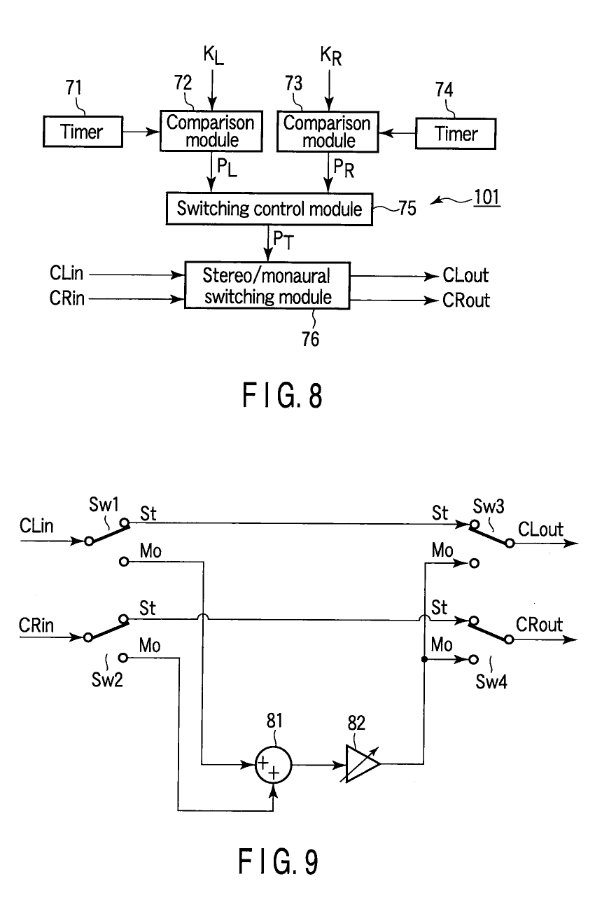

FIG. 8 shows a structure example of the sound output control module 101.

The sound output control module 101 includes a timer 71, a comparison module 72, a comparison module 73, a timer 74, a switching control module 75 and a stereo/monaural switching module 76.

The comparison module 72 compares an elapsed time after the value of the first wearing detection signal K_{L} becomes higher than the threshold value Th with a first predetermined time which is given by the timer 71, thereby to determine that the first headphone E_{L} is worn on the human body, on condition that the value of the first wearing detection signal K_{L} is continuously higher than the threshold value Th for the first predetermined time or more which is given by the timer 71. If the value of the first wearing detection signal K_{L} is continuously higher than the threshold value Th for the first predetermined time or more which is given by the timer 71, the comparison module 72 outputs a control signal P_{L} of logic “1”. The control signal P_{L} of logic “1” indicates that the first headphone E_{L} is worn on the human body. The first predetermined time can be set between about one second and about three seconds, for example, at about two seconds.

In addition, the comparison module 72 compares an elapsed time after the value of the first wearing detection signal K_{L} lowers to the threshold value Th or less with the first predetermined time, thereby to determine that the first headphone E_{L} is not worn on the human body, on condition that the value of the first wearing detection signal K_{L} is continuously the threshold value Th or less for the first predetermined time or more. If the value of the first wearing detection signal K_{L} is continuously the threshold value Th or less for the first predetermined time or more, the comparison module 72 outputs a control signal P_{L} of logic “0”. The control signal P_{L} of logic “0” indicates that the first headphone E_{L} is not worn on the human body.

The comparison module 73 compares an elapsed time after the value of the second wearing detection signal K_{R} becomes higher than the threshold value Th with a second predetermined time which is given by the timer 74, thereby to determine that the second headphone E_{R} is worn on the human body, on condition that the value of the second wearing detection signal K_{R} is continuously higher than the threshold value Th for the second predetermined time or more which is given by the timer 74. If the value of the second wearing detection signal K_{R} is continuously higher than the threshold value Th for the second predetermined time or more which is given by the timer 74, the comparison module 73 outputs a control signal P_{R} of logic “1”. The control signal P_{R} of logic “1” indicates that the second headphone E_{R} is worn on the human body. The second predetermined time can be set, for example, at the same value as the first predetermined value.

In addition, the comparison module 73 compares an elapsed time after the value of the second wearing detection signal K_{R} lowers to the threshold value Th or less with the second predetermined time, thereby to determine that the second headphone E_{R} is not worn on the human body, on condition that the value of the second wearing detection signal K_{R} is continuously the threshold value Th or less for the second predetermined time or more. If the value of the second wearing detection signal K_{R} is continuously the threshold value Th or less for the second predetermined time or more, the comparison module 73 outputs a control signal P_{R} of logic “0”. The control signal P_{R} of logic “0” indicates that the second headphone E_{R} is not worn on the human body.

With the above-described structure, it is possible to prevent the sensitivity of detection of the wearing/non-wearing state from becoming excessively high, and to prevent the occurrence of frequent switching between the stereo mode and the monaural mode.

The switching control module 75 determines, on the basis of the control signal P_{L} and control signal P_{R}, whether the wearing state of the first headphone E_{L} and the second headphone E_{R} is the both-ear wearing state or one-ear wearing state. Specifically, if both the control signal P_{L} and control signal P_{R} are logic “1”, the switching control module 75 outputs a switching control signal P_{T} of logic “1” to the stereo/monaural switching module 76. The switching control signal P_{T} of logic “1” indicates that the wearing state is the both-ear wearing state. If one of the control signal P_{L} and control signal P_{R} is logic “0”, the switching control module 75 outputs a switching control signal P_{T} of logic “0” to the stereo/monaural switching module 76. The switching control signal P_{T} of logic “0” indicates that the wearing state is the one-ear wearing state.

In accordance with the switching control signal P_{T}, the stereo/monaural switching module 76 sends one of the stereo audio signal and monaural audio signal to the pair of headphones E_{L} and E_{R}. Specifically, while the switching control signal P_{T} is logic “1”, the stereo/monaural switching module 76 sends the left-channel audio signal CLᵢₙ, which is input from the playback module 102, to the first headphone E_{L} as the left-channel audio output signal CLₒᵤₜ, and sends the right-channel audio signal CRᵢₙ, which is input from the playback module 102, to the second headphone E_{R} as the right-channel audio output signal CRₒᵤₜ. While the switching control signal P_{T} is logic “0”, the stereo/monaural switching module 76 generates a monaural audio signal by mixing the left-channel audio signal CLᵢₙ and the right-channel audio signal CRᵢₙ, and sends the generated monaural audio signal to at least one of the first headphone E_{L} and second headphone E_{R}.

FIG. 9 schematically shows the stereo/monaural switching module 76.

The stereo/monaural switching module 76 includes four switches Sw1 to Sw4, which correspond to the left-channel audio signal CLᵢₙ, right-channel audio signal CRᵢₙ, left-channel audio output signal CLₒᵤₜ and right-channel audio output signal CRₒᵤₜ, and an addition unit 81.

Each of the four switches Sw1 to Sw4 is connected to a stereo terminal (St) side when the switching control signal P_{T} is logic “1”. In this case, the left-channel audio signal CLᵢₙ is sent to the first headphone E_{L} as the left-channel audio output signal CLₒᵤₜ, and the right-channel audio signal CRᵢₙ is sent to the second headphone E_{R} as the right-channel audio output signal CRₒᵤₜ.

Each of the four switches Sw1 to Sw4 is connected to a monaural terminal (Mo) side when the switching control signal P_{T} is logic “0”. In this case, the left-channel audio signal CLᵢₙ and the right-channel audio signal CRᵢₙ are sent to the addition unit 81. The addition unit 81 adds the left-channel audio signal CLᵢₙ and the right-channel audio signal CRᵢₙ, thereby mixing the left-channel audio signal CLᵢₙ and the right-channel audio signal CRᵢₙ and generating the monaural audio signal.

A volume adjusting unit 82 may additionally be provided in the stereo/monaural switching module 76. The volume adjusting unit 82 automatically varies the volume of the monaural audio signal, which is obtained by the addition unit 81, by a predetermined amount. Usually, there are cases in which the volume of sound, which is listenable for humans, varies between the case in which sound is listened to by both ears and the case in which sound is listened to by one ear alone. In addition, in many cases, the proper volume in the case where a stereo audio signal is listened to by both ears is different from the proper volume in the case where a monaural audio signal is listened to by one ear. Thus, the volume adjusting unit 82 automatically adjusts the volume of the monaural audio signal, and thereby a more listenable audio signal can be output.

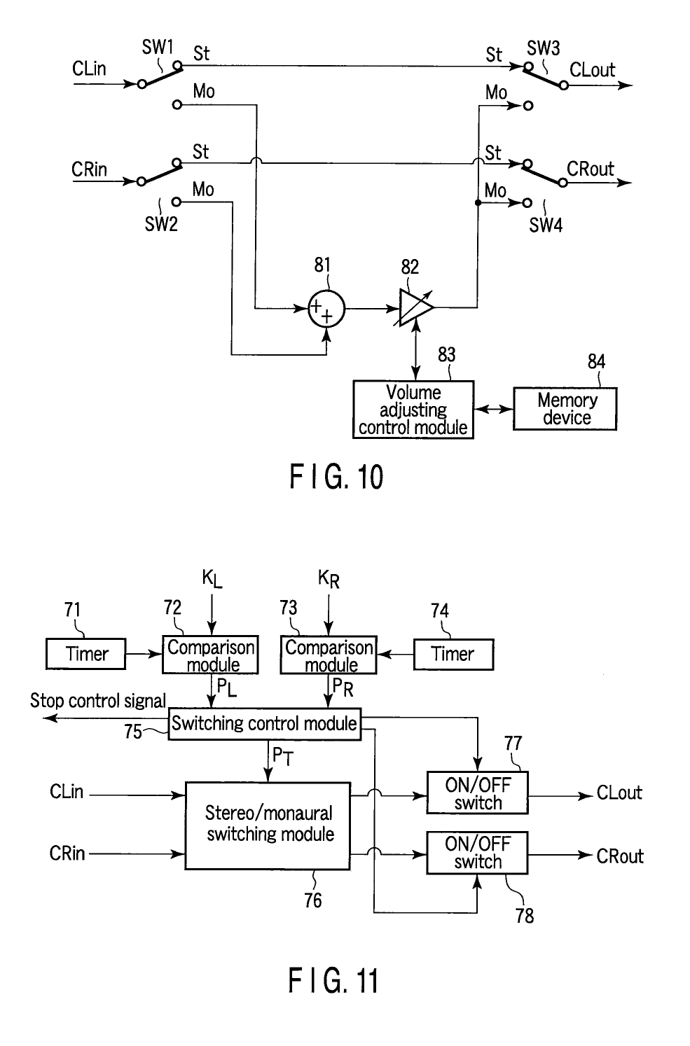

FIG. 10 shows an example in which a volume adjusting control module 83 and a memory device 84 are further provided in the sound output control module 101.

The memory device 84 stores a volume set value which is set by the user during the period in which the wearing state of the first headphone E_{L} and second headphone E_{R} is the one-ear wearing state. Specifically, a volume value, which is finally adjusted by the user during the period in which the user is listening to the audio signal in the monaural mode, is stored in the memory device 84.

Each time the wearing state of the first headphone E_{L} and second headphone E_{R} is transitioned from the both-ear wearing state to the one-ear wearing state, the volume set value stored in the memory device 84 is read out by the volume adjusting control module 83, and read-out volume set value is delivered to the volume adjusting unit 82. The volume adjusting unit 82 automatically varies the volume of the generated monaural audio signal so that the volume of the generated monaural audio signal may be adjusted to the volume set value.

The structure shown in FIG. 10 is applicable to each of the structure (FIG. 3) in which the sound output control module 101 is provided in the player apparatus 10, and the structure (FIG. 4) in which the sound output control module 101 is provided in the additional device 12. In particular, in the case where the structure of FIG. 10 is applied to the structure of FIG. 4, the volume set value is stored in the additional device 12. Thus, even if the player apparatus is changed, the volume of the monaural audio signal can be set at the proper volume set value which is set by the user at the previous time of the monaural mode.

FIG. 11 shows a modification of the sound output control module 101.

The sound output control module 101 shown in FIG. 11 includes a first ON/OFF switch 77 and a second ON/OFF switch 78, in addition to the above-described timer 71, comparison modules 72, 73, timer 74, switching control module 75 and stereo/monaural switching module 76.

The first ON/OFF switch 77 is connected to an output terminal for the left-channel audio output signal CLₒᵤₜ of the stereo/monaural switching module 76, and permits/prohibits the output of the left-channel audio output signal CLₒᵤₜ. Specifically, when the control signal P_{L} is logic “0”, the first ON/OFF switch 77 is turned off, and thus the output of the left-channel audio output signal CLₒᵤₜ is prohibited. When the control signal P_{L} is logic “1”, the first ON/OFF switch 77 is turned on, and thus the output of the left-channel audio output signal CLₒᵤₜ is permitted.

The second ON/OFF switch 78 is connected to an output terminal for the right-channel audio output signal CRₒᵤₜ of the stereo/monaural switching module 76, and permits/prohibits the output of the right-channel audio output signal CRₒᵤₜ. Specifically, when the control signal P_{R} is logic “0”, the second ON/OFF switch 78 is turned off, and thus the output of the right-channel audio output signal CRₒᵤₜ is prohibited. When the control signal P_{R} is logic “1”, the second ON/OFF switch 78 is turned on, and thus the output of the right-channel audio output signal CRₒᵤₜ is permitted.

In the case where the first headphone E_{L} is worn on the human body and the second headphone E_{R} is not worn on the human body, the control signal P_{L} is logic “1” and the control signal P_{R} is logic “0”. In this case, the first ON/OFF switch 77 is turned on and the second ON/OFF switch 78 is turned off. Accordingly, the monaural signal, which is generated by the stereo/monaural switching module 76, is sent to only the first headphone E_{L} via the first ON/OFF switch 77, and is not sent to the second headphone E_{R}. Therefore, sound leak from the second headphone E_{R} can be prevented.

In the case where the first headphone E_{L} is not worn on the human body and the second headphone E_{R} is worn on the human body, the control signal P_{L} is logic “0” and the control signal P_{R} is logic “1”. In this case, the first ON/OFF switch 77 is turned off and the second ON/OFF switch 78 is turned on. Accordingly, the monaural signal, which is generated by the stereo/monaural switching module 76, is sent to only the second headphone E_{R} via the second ON/OFF switch 78, and is not sent to the first headphone E_{L}. Therefore, sound leak from the first headphone E_{L} can be prevented.

In the case where neither the first headphone E_{L} nor the second headphone E_{R} is worn on the human body, the control signal P_{L} is logic “0” and the control signal P_{R} is logic “0”. In this case, the first ON/OFF switch 77 is turned off and the second ON/OFF switch 78 is also turned off. Accordingly, the monaural signal is sent to neither the first headphone E_{L} nor the second headphone E_{R}. Therefore, sound leak from the first headphone E_{L} and the second headphone E_{R} can be prevented.

In addition, in the case where neither the first headphone E_{L} nor the second headphone E_{R} is worn on the human body, that is, in the case where the control signal P_{L} is logic “0” and the control signal P_{R} is logic “0”, the switching control module 75 sends to the playback module 102 a stop control signal which instructs the stop of the playback operation (e.g. a signal instructing a pause, or a signal instructing a transition to a sleep state), thereby stopping the playback operation of the playback module 102. Hence, the power consumption in the case where neither the first headphone E_{L} nor the second headphone E_{R} is worn on the human body can greatly be reduced.

As has been described above, according to the present embodiment, the operation mode is automatically switched from the stereo mode to the monaural mode in response to a transition from the both-ear wearing mode to the one-ear wearing mode. Therefore, even if the user does not manually switch the operation mode to the monaural mode, the user can listen to sound, which is free of unnaturalness, by one ear alone.

In addition, when the stereo mode is switched to the monaural mode, the volume of the monaural audio signal is automatically varied by the volume adjusting unit 82, and automatically adjusted to a proper volume level for listening of the monaural audio signal by one ear of the user. If the operation mode is restored from the monaural mode to the stereo mode, the stereo audio signal is sent, not through the volume adjusting unit 82, to the first headphone E_{L} and the second headphone E_{R}, and thus the volume level can be restored to a volume level that is proper to the stereo mode.

The function of the sound output control module 101 can also be realized by a program which is executed by a microprocessor or a DSP. In addition, the first ON/OFF switch 77 and the second ON/OFF switch 78 may be built in the first headphone E_{L} and the second headphone E_{R}, respectively. In this case, for example, the sound output control module 101 may be configured to supply only control signals, which ON/OFF control the first ON/OFF switch 77 and the second ON/OFF switch 78, to the first headphone E_{L} and the second headphone E_{R}.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A sound output control device comprising:
an output control module configured to detect, based on a first wearing detection signal which is sent from a first headphone and a second wearing detection signal which is sent from a second headphone, whether a wearing state of the first headphone and the second headphone is a first state in which both the first headphone and the second headphone are worn on the human body, or a second state in which one of the first headphone and the second headphone is worn on the human body and the other of the first headphone and the second headphone is not worn on the human body, to send, in a case of the first state, a left-channel audio signal and a right-channel audio signal, which are included in a stereo audio signal which is output from a playback unit, to the first headphone and the second headphone, respectively, and to generate, in a case of the second state, a monaural audio signal by mixing the left-channel audio signal and the right-channel audio signal to send the generated monaural audio signal to the one of the first headphone and the second headphone.

2. The sound output control device of claim 1, wherein in a case of the second state, the output control module is configured to vary a volume of the generated monaural audio signal by a predetermined amount, and to send the monaural audio signal, the volume of which is varied, to the one of the first headphone and the second headphone.

3. The sound output control device of claim 1, wherein in a case of the second state, the output control module is configured to prohibit transmission of the monaural audio signal to the other of the first headphone and the second headphone.

4. The sound output control device of claim 1, wherein the output control module is configured to detect that the first headphone is worn on the human body, on condition that a value of the first wearing detection signal is continuously higher than a threshold value for a first predetermined time or more, to detect that the first headphone is not worn on the human body, on condition that the value of the first wearing detection signal is continuously the threshold value or less for the first predetermined time or more, to detect that the second headphone is worn on the human body, on condition that a value of the second wearing detection signal is continuously higher than the threshold value for a second predetermined time or more, and to detect that the second headphone is not worn on the human body, on condition that the value of the second wearing detection signal is continuously the threshold value or less for the second predetermined time or more.

5. The sound output control device of claim 1, further comprising:
a memory configured to store a volume set value which is set by a user during a period in which the wearing state of the first headphone and the second headphone is the second state; and
a volume varying module configured to read out, in a case where the wearing state of the first headphone and the second headphone is transitioned from the first state to the second state, the volume set value which is stored in the memory device, to vary a volume of the monaural audio signal, and to adjust the volume of the generated monaural audio signal to the read-out volume set value.

6. A sound playback apparatus comprising:
a first headphone including a first contact sensor, the first contact sensor being configured to detect contact of the first headphone with a human body and to output a first wearing detection signal which is indicative of whether or not the first headphone is worn on the human body;
a second headphone including a second contact sensor, the second contact sensor being configured to detect contact of the second headphone with the human body and to output a second wearing detection signal which is indicative of whether or not the second headphone is worn on the human body; and
a sound output control module configured to detect, on the basis of the first wearing detection signal and the second wearing detection signal, whether a wearing state of the first headphone and the second headphone is a first state in which both the first headphone and the second headphone are worn on the human body, or a second state in which one of the first headphone and the second headphone is worn on the human body and the other of the first headphone and the second headphone is not worn on the human body, to send, in a case of the first state, a left-channel audio signal and a right-channel audio signal, which are included in a stereo audio signal which is output from a playback unit, to the first headphone and the second headphone, respectively, and to generate, in a case of the second state, a monaural audio signal by mixing the left-channel audio signal and the right-channel audio signal, and send the generated monaural audio signal to the one of the first headphone and the second headphone.

7. The sound playback apparatus of claim 6, wherein in a case where the wearing state of the first headphone and the second headphone is the second state, the sound output control module is configured to vary a volume of the generated monaural audio signal by a predetermined amount, and to send the monaural audio signal, the volume of which is varied, to the one of the first headphone and the second headphone.

8. The sound playback apparatus of claim 6, wherein the sound output control module is provided in a player apparatus including the playback unit.

9. The sound playback apparatus of claim 6, wherein the sound output control module is provided in an additional device which is detachably connected to a player apparatus including the playback unit, the sound output control module is configured to receive the stereo audio signal which is output from the playback unit, and to transmit the received stereo audio signal to the first headphone and the second headphone.

10. The sound playback apparatus of claim 9, wherein the additional device includes a memory device configured to store a volume set value which is set by a user during a period in which the wearing state of the first headphone and the second headphone is the second state; and
the sound output control module includes a volume varying module configured to read out, in a case where the wearing state of the first headphone and the second headphone is transitioned from the first state to the second state, the volume set value which is stored in the memory device, to vary a volume of the monaural audio signal, and to adjust the volume of the generated monaural audio signal to the read-out volume set value.

11. A sound output control method for outputting an audio signal to each of a first headphone and a second headphone, comprising:
detecting, on the basis of a first wearing detection signal which is sent from the first headphone and is indicative of whether or not the first headphone is worn on a human body and a second wearing detection signal which is sent from the second headphone and is indicative of whether or not the second headphone is worn on the human body, whether a wearing state of the first headphone and the second headphone is a first state in which both the first headphone and the second headphone are worn on the human body, or a second state in which one of the first headphone and the second headphone is worn on the human body and the other of the first headphone and the second headphone is not worn on the human body;
sending, in a case where the wearing state of the first headphone and the second headphone is the first state, a left-channel audio signal and a right-channel audio signal, which are included in a stereo audio signal which is output from a playback unit, to the first headphone and the second headphone, respectively; and
generating, in a case where the wearing state of the first headphone and the second headphone is the second state, a monaural audio signal by mixing the left-channel audio signal and the right-channel audio signal, and sending the generated monaural audio signal to the one of the first headphone and the second headphone.

12. The sound output control method of claim 11, further comprising varying a volume of the generated monaural audio signal by a predetermined amount, in a case where the wearing state of the first headphone and the second headphone is the second state.
